(19) United States
(12) Patent Application Publication
(10) Pub. No.: US 2018/0206014 A1
(43) Pub. Date: Jul. 19, 2018

(54) BRACKET FOR USE IN MOUNTING A LOUDSPEAKER IN A WALL OR CEILING

(71) Applicant: Monitor Audio Limited, Rayleigh (GB)

(72) Inventors: Rianna Francesca Foster, Hemel Hempstead (GB); Charles Edward Minett, London (GB); Dean Stephen Hartley, Wakefield (GB); Matthew Alexander Robert Sharp, Ingatestone (GB)

(21) Appl. No.: 15/866,805

(22) Filed: Jan. 10, 2018

(30) Foreign Application Priority Data
Jan. 19, 2017 (GB) 1700910.1

(51) Int. Cl. H04R 1/02

(52) U.S. Cl. CPC H04R 1/025; H04R 2201/021

(57) ABSTRACT

A bracket for use in mounting a loudspeaker in a wall or ceiling, the bracket comprising a ridge for defining at least part of the perimeter of the aperture in the finished wall or ceiling; an abutment, such as shoulders, for limiting the distance by which the loudspeaker can be inserted into the aperture in a wall or ceiling panel; and a retainer for cooperating with one or more fasteners to retain the loudspeaker in position with respect to the bracket.

### FIELD

This disclosure relates to a bracket for use in mounting a loudspeaker in a wall or ceiling, and to a loudspeaker and such a bracket.

### BACKGROUND

The present disclosure is particularly applicable to loudspeaker mounting brackets which provide a mud bank or mud ring.

Such brackets are commonly used to mount loudspeakers in apertures in ceiling or wall panels which are also coated with plaster, after installation of the panels, in order to provide a neat, visually appealing finish. The mud bank/ring takes the form of a ridge which is typically either annular or square and which, with the bracket mounted in position, stands slightly proud of the panel face. This enables the layer of plaster then to be applied, with the ridge then providing a neat finish to the plastered surface at the edge of the aperture in which the loudspeaker is to be is mounted.

Typically, the mounting bracket is part of a bracket assembly that is attached to a supporting structure, such as a pair of joists, behind a panel. In order to ensure that the loudspeaker is correctly positioned relative to the ceiling or wall (typically so that the loudspeaker grill is flush with the ceiling/wall), the bracket assembly needs to be adjusted as different ceiling/wall panels have different thicknesses. The requirement for adjustability increases the complexity of the construction of the bracket assembly, and the levelling adjustments required to get the correct depth for flush finish can be time consuming.

### SUMMARY

Brackets for use in mounting loudspeakers in a wall or a ceiling and brackets in combination with loudspeakers are disclosed. Some brackets according to the present disclosure comprise a ridge for defining at least part of a perimeter of an aperture in the finished wall or ceiling; an abutment for limiting a distance by which the loudspeaker can be inserted into the aperture in a wall panel or a ceiling panel; and a retainer for cooperating with one or more fasteners to retain the loudspeaker in position with respect to the bracket.

### BRIEF DESCRIPTION OF THE DRAWINGS

FIG. 1 is an exploded perspective view, from below, of a bracket assembly in accordance with the present disclosure, a portion of ceiling panel and a loudspeaker to be attached to the panel by the bracket assembly;

FIG. 2 is a corresponding view from above;

FIG. 3 is an isometric view, showing the upper face of a preconstruction bracket which comprises a first part of the bracket assembly;

FIG. 4 is a plan view of the underside of the preconstruction bracket;

FIG. 5 is an isometric view, also of the underside of the bracket assembly a loudspeaker;

FIG. 6 is a plan view, from below, of a mud bank or mud ring which comprises a second part of the bracket assembly;

FIG. 7 is a side elevation of the second part;

FIG. 8 is a plan view, from above of the second part;

FIG. 9 is a plan view taken along the line A-A in FIG. 8;

FIG. 10 is an exploded perspective view of the second part and a plaster shield for use during the installation of the assembly and the plastering of the ceiling;

FIG. 11 is a view which corresponds to FIG. 10, showing the components when viewed from below;

FIG. 12 is a side elevation of the assembled bracket assembly and a loudspeaker mounted therein (the ceiling panel has been omitted for the sake of clarity);

FIG. 13 is an isometric view from above the bracket assembly, the loudspeaker and a ceiling panel;

FIGS. 14 and 15 are respective side elevations and sectional views of that arrangement; and

FIGS. 16-19 are views, respectively corresponding to FIGS. 6-9, of an alternative type of second part of the bracket assembly, for use with a loudspeaker having a square grill.

### DESCRIPTION

According to a first aspect of the disclosure, there is provided a bracket for use in mounting a loudspeaker in a wall or ceiling, the bracket comprising a ridge for defining at least part of the perimeter of the aperture in the finished wall or ceiling; an abutment for limiting the distance by which the loudspeaker can be inserted into the aperture in a wall or ceiling panel; and a retainer for cooperating with one or more fasteners to retain the loudspeaker in position with respect to the bracket.

Since the bracket limits the distance by which the loudspeaker can be inserted into the aperture, it facilitates the correct positioning of the loudspeaker relative to the wall or ceiling panel. Thus, if the bracket is attached directly to the panel, it can automatically ensure correct axial positioning of the loudspeaker relative to the panel: variations of panel thickness will not affect the alignment of the loudspeaker as this will be governed by the axial distance between the abutment and the ridge. The present disclosure thus facilitates the mounting of the loudspeaker so that its grill is in a desired position relative to the wall or ceiling, for example flush with the finished wall or ceiling.

In some examples, therefore, the bracket also includes an attachment structure, such as screw holes, by which the bracket can be directly attached to a wall or ceiling panel.

In some examples, the ridge is continuous so as to enclose the aperture.

In this case, the ridge may for example be annular or polygonal (e.g. square or rectangular).

In some examples, the abutment comprises a radial shoulder.

In some examples, the shoulder is annular.

In some examples, the bracket comprises a bracket assembly having a first part for attachment to a structural support behind the wall, or above the ceiling, and a second, separate part having said ridge and abutment, the second part being attachable both to the first part and the ceiling panel.

In some examples, the second part of the bracket assembly includes a protuberance for insertion through the aperture in the wall or ceiling panel, the first part having a receiving structure for receiving the protuberance to provide location of the two parts relative to each other at any of a range of possible axial positions.

It will be appreciated that, for the purposes of this specification, the term “axial” refers to an axis which is perpendicular to the wall or ceiling and passes through the centre of the aperture in the wall or ceiling. Such an axis would coincide with the axis of a loudspeaker which has a symmetrically arranged centrally mounted drive unit. However, the bracket assembly according to the present disclosure could be used with other types of loudspeakers, the axis in any case referring to the direction along which the loudspeaker in question is inserted into the wall or ceiling aperture.

The protuberance and the receiving structure thus cooperate to align the two parts of the bracket assembly in directions perpendicular to the direction of insertion of the second part, i.e. parallel to the plane of the wall or ceiling. Because the allowable separation between the two parts is variable, the bracket assembly can be used with wall or ceiling panels of differing thicknesses.

In some examples, the protuberance comprises a boss.

In some examples, the boss comprises a cylindrical wall.

In this case, the abutment projects radially inwardly from the boss.

In some examples, the receiving structure comprises an aperture or passage in the first part into which the boss is a sliding fit, and the receiving structure, in use, locates the boss at a position coaxial with the aperture or passage in the first part.

This enables a loudspeaker installed in the bracket assembly to be at least partially accommodated by the first and second parts.

In some examples, the first and second parts are configured to be fastened together by fasteners, extending through the wall or ceiling panel, which is thereby clamped between the first and second parts of the bracket assembly.

In some examples, the first part has passages or through holes for enabling fastening screws, having been inserted through the second part, to pass through or into the first part by a variable distance to enable panels of a range of possible thicknesses to be clamped between the first and second parts of the bracket assembly.

In some examples, the second part includes a flange that surrounds the ridge and sits, in use, against the opposite side of the wall or ceiling panel from the first part of the bracket assembly, the flange including holes or passages for screws, for fastening the first and second parts together.

In some examples, the first and second parts of the bracket assembly include angular location structure for ensuring that the second part is inserted into the first part with the screw holes or passages of the second part aligned with the screw passages or through holes in the first part.

In some examples, the angular location structure comprises a protuberance on one of the parts that cooperate with a female receptor, such as a slot or recess, on the other part, to allow the insertion of the second part only when in a predetermined angular position relative to the first part.

This greatly facilitates the fastening of the first and second parts of the assembly since the second part will always be inserted with its screw holes aligned with the screw holes/passages in the first part, despite the fact that the view of those holes/passages will be blocked by the wall or ceiling panel.

In some examples, the second part includes further screw holes via which a loudspeaker can be attached to the bracket by screws, the second part also having loudspeaker angular location structure for ensuring angular alignment between the loudspeaker and the bracket assembly.

In some examples, the loudspeaker angular location structure comprises a radial ledge having a gap or break for accommodating a complimentary protuberance on the loudspeaker.

The present disclosure also lies in a loudspeaker, preferably having a driver other than a tweeter and a bracket as aforesaid.

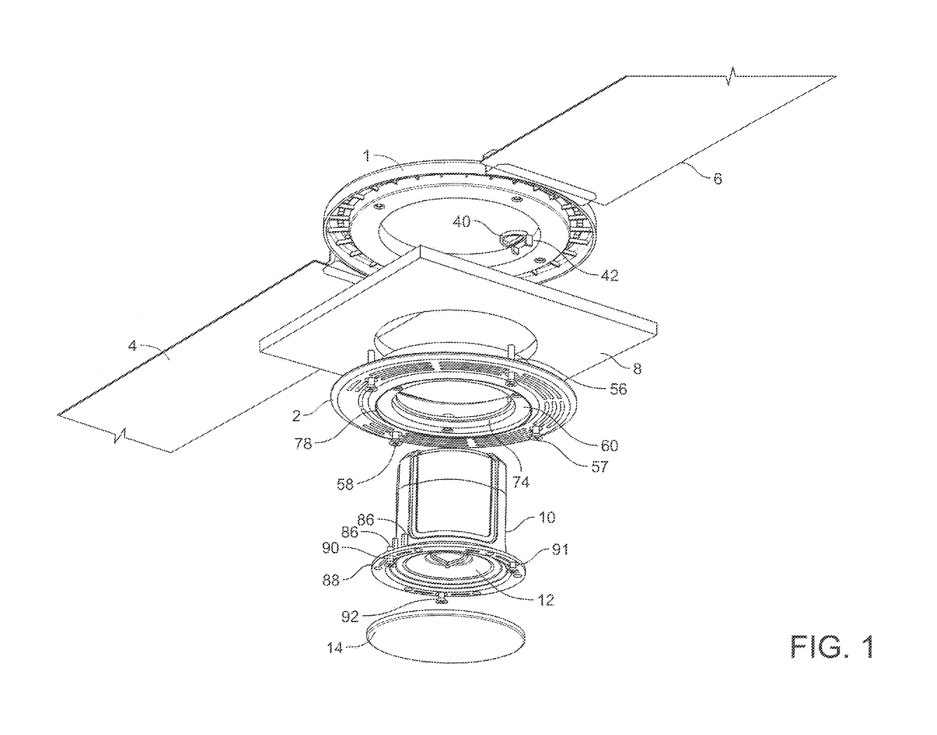

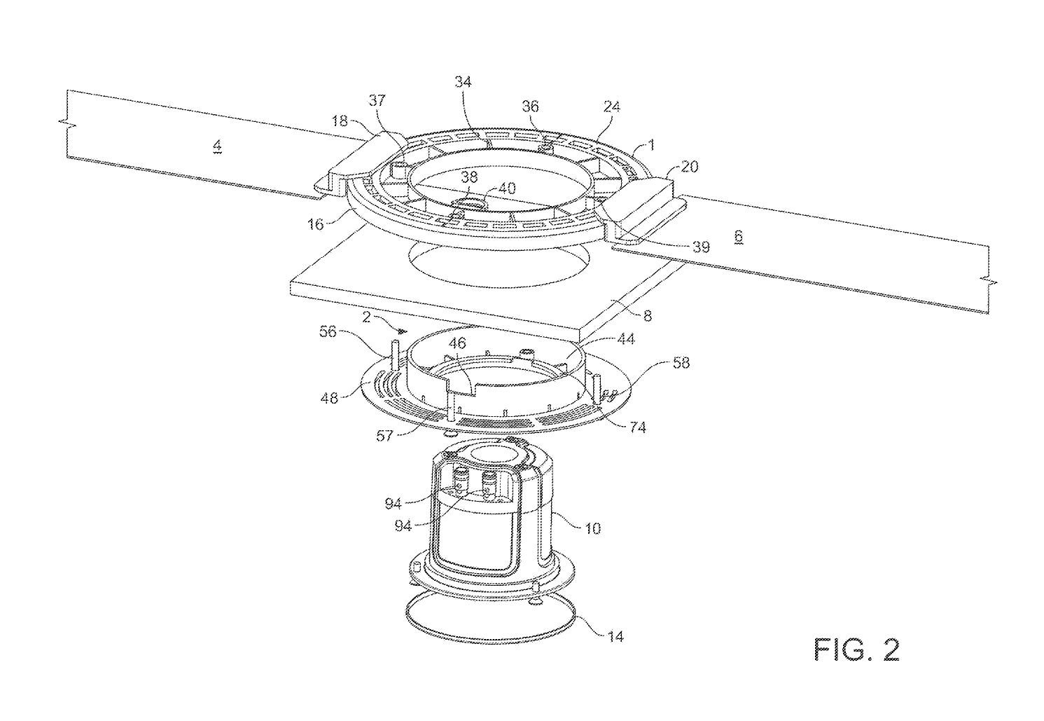

With reference to FIGS. 1 and 2, a bracket assembly in accordance with the present disclosure comprises a first part in the form of a preconstruction bracket 1 and a second part 2 which acts as a mud bank or mud ring. The preconstruction bracket is attached to a pair of ceiling joists (not shown) on either side of the preconstruction bracket 1 via mesh wings 4 and 6 (which may, for example, take the form of straps). The preconstruction bracket 1 is in use screwed to the second part 2 so that a ceiling panel, part of which is shown at 8, is clamped between the two parts (with the screws that fasten the two parts together extending through the panel). The bracket assembly is adapted to receive, and retain a loudspeaker 10 having a generally cylindrical body and circular diaphragm 12 which, in use, is covered by circular grill 14.

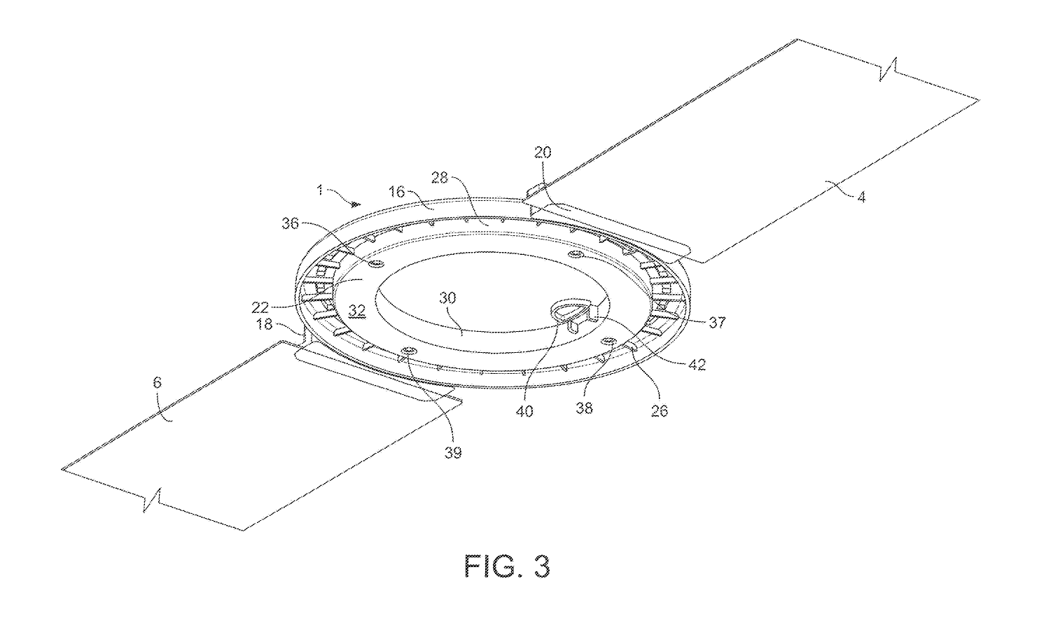

With reference to FIG. 3, the preconstruction bracket 1 may be formed from a one-piece injection moulding of a suitable thermoplastics material, for example ABS, and is generally annular, having a cylindrical outer wall 16 to which are attached, at diametrically opposed positions, two clips for attaching the preconstruction bracket to the mesh wings 4 and 6, and hence to a pair of ceiling joists (in a conventional manner). The outer wall 16 is concentric with an inner ring 22 connected to the wall via an apertured top face 24 (see FIG. 2) and a series of identical, equi-angularly arranged radial strengthening ribs, such as the rib 26. The ring 22, in turn, comprises an outer cylindrical wall 28 separated from an inner cylindrical wall 30 via an annular lower face 32. As can be seen from FIG. 2, further, equi-angularly arranged strengthening ribs, such as rib 34, also connect the walls 28 and 30. In FIG. 2, reference numerals 36-39 denote four axial cylindrical passages (i.e. passages whose axes are parallel to that of the ring 22), each of which is integrally formed with a respective one of the strengthening ribs between the walls 28 and 30. Each of the passages 36-39 includes a respective screw threaded bushing so that the second part 2 can be fastened to the preconstruction bracket 1 by screws which can be screwed into the preconstruction bracket 1 by an amount that varies independent of the thickness of the ceiling panel 8.

A D-ring 40 is attached to the top of the wall 30. The wiring for the speaker 10 can be tied to the D-ring 40 so that those wires may be easily located and connected to the loudspeaker 10 when the latter is to be installed.

A generally C-shaped radial inward protuberance 42 is provided on the wall 30 at the same angular position as the D-ring 40. The function of the protuberance 42 is to ensure that the second part 2 is in the correct angular position as it is inserted into the preconstruction bracket.

The wall 30 defines a central circular aperture in the preconstruction bracket, in which a cylindrical, axial boss 44 of the second part is a close sliding fit.

The top of the wall 30 is stepped to define a generally U-shaped slot 46 which acts as a female receptor for the protuberance 42, so that the boss 44 cannot be properly inserted into the aperture in the preconstruction bracket 1 unless the slot 46 is aligned with the protuberance 42. When the protuberance 42 and slot 46 are so aligned, the boss 44 may be inserted into the aperture defined by the wall 30, with the slot 46 accommodating the protuberance 42.

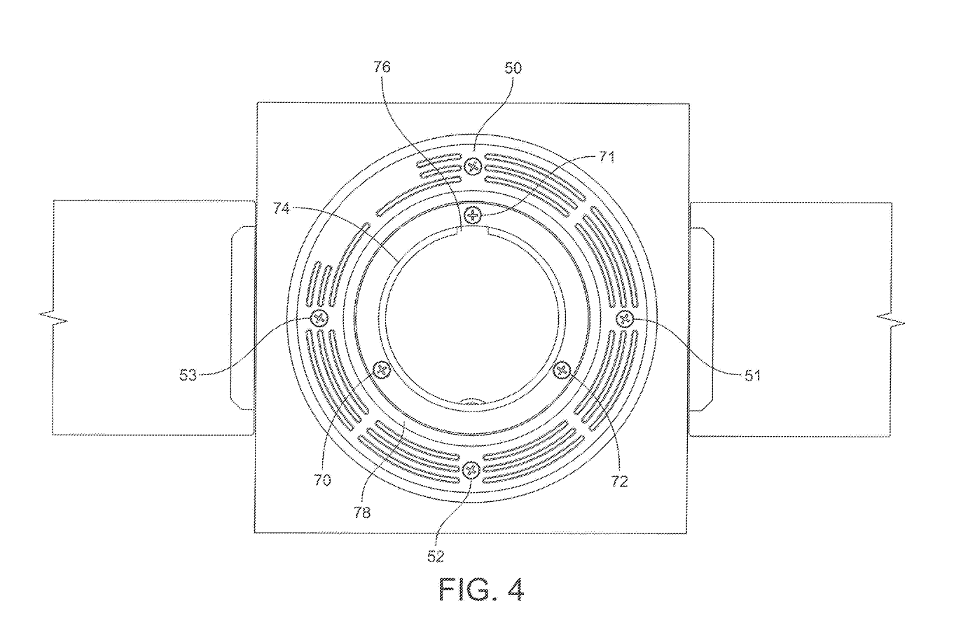

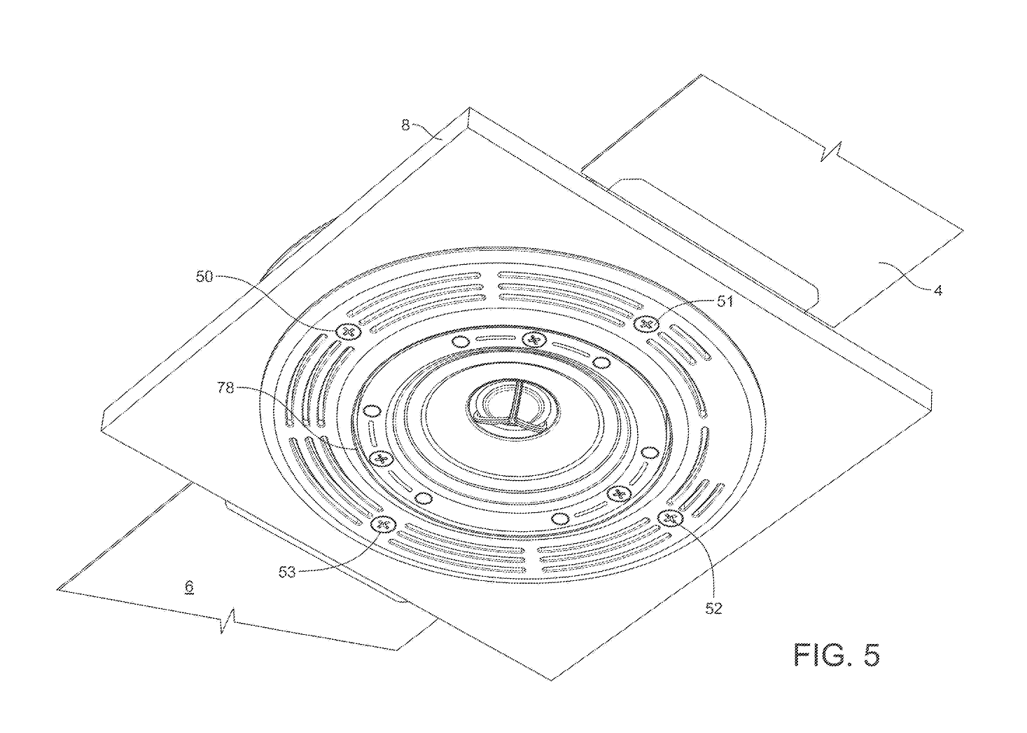

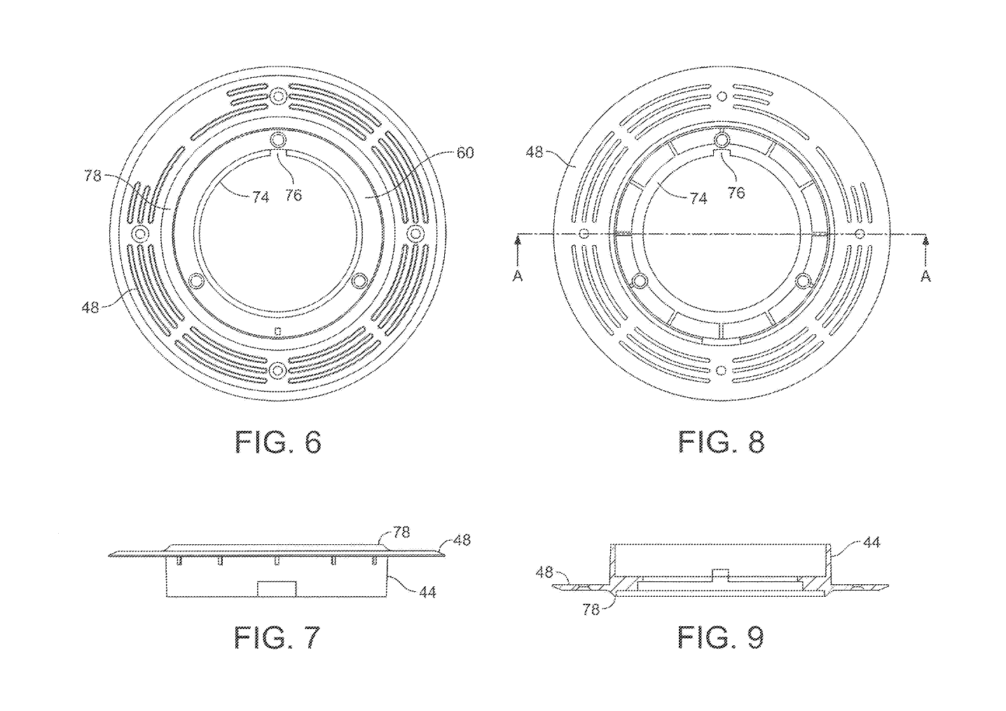

A flange 48 projects radially outwardly from the bottom of the boss 44, and includes four equi-angularly arranged screw holes 50-53 which, in use, receive screws, three of which are shown at 56-58 in FIG. 4. Each of the screws is installed by being passed through the respective hole in the flange 48, through the panel 8 and into a respective one of the passages 36-39 so as to clamp the panel 8 between the preconstruction bracket 1 and the second part 2. It will be appreciated that, since the screws can extend into the passages 36-39 by varying amounts, different thicknesses of panel 8 can be accommodated. It will also be appreciated that the co-operation between the protuberance 42 and slot 46 ensures that the holes 50-53 are aligned with the passages 36-39 so that the screws may be easily inserted.

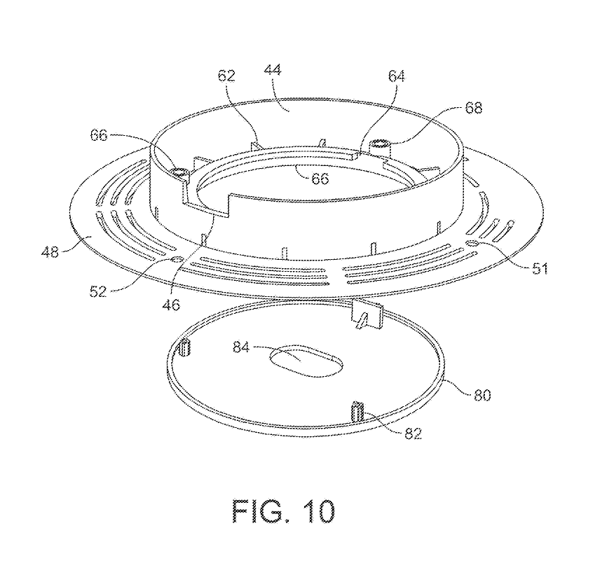

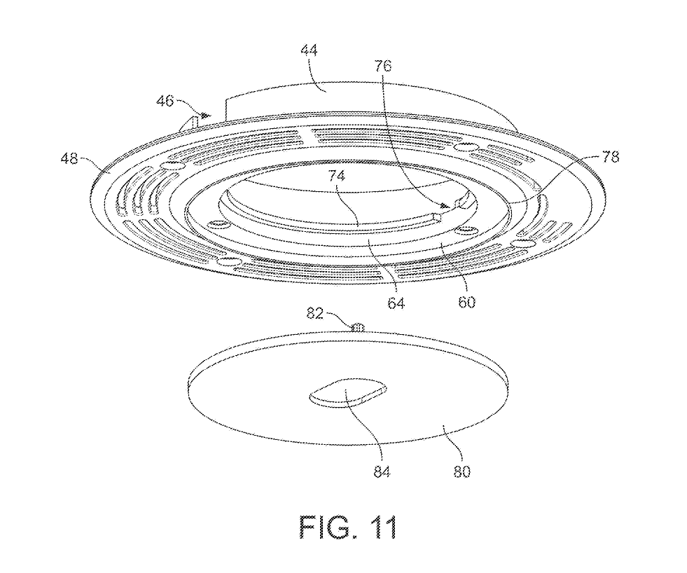

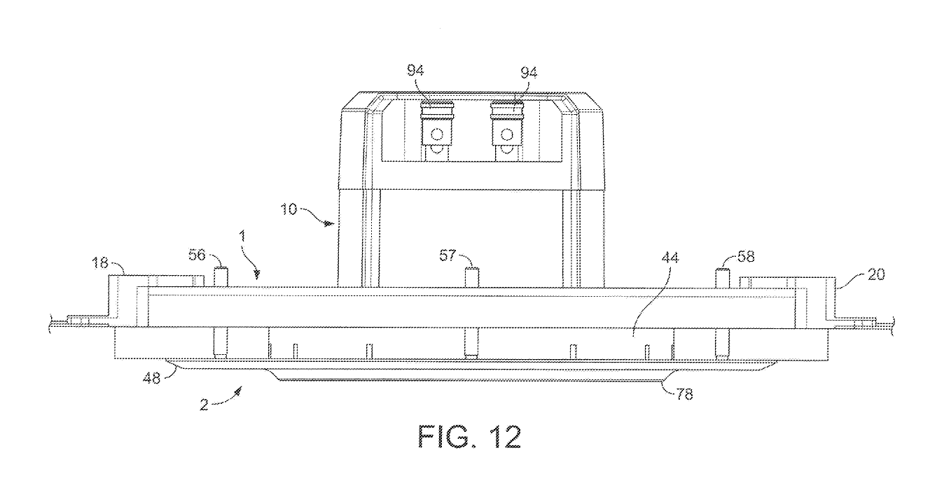

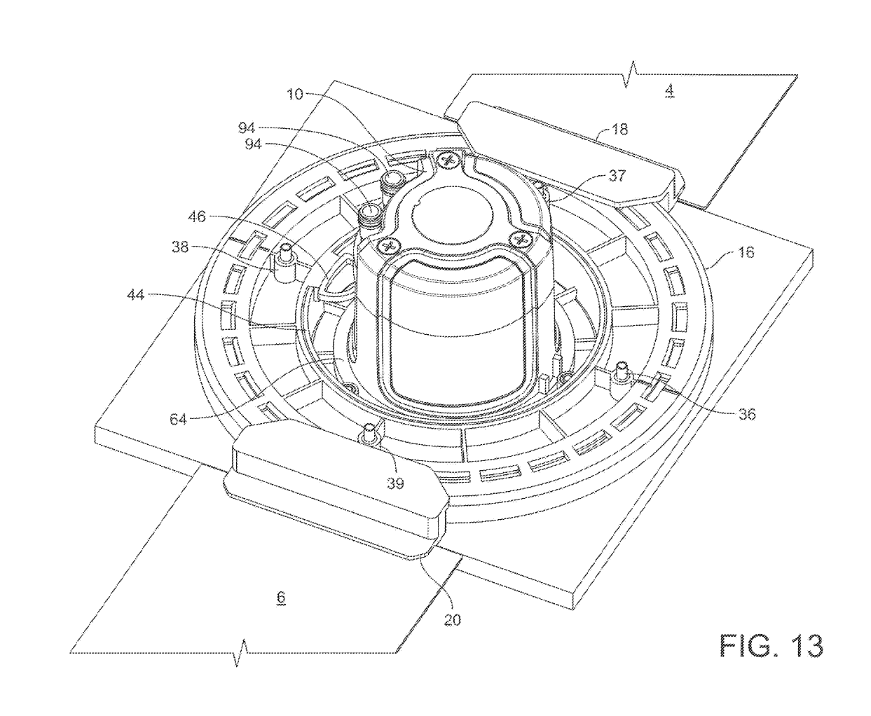

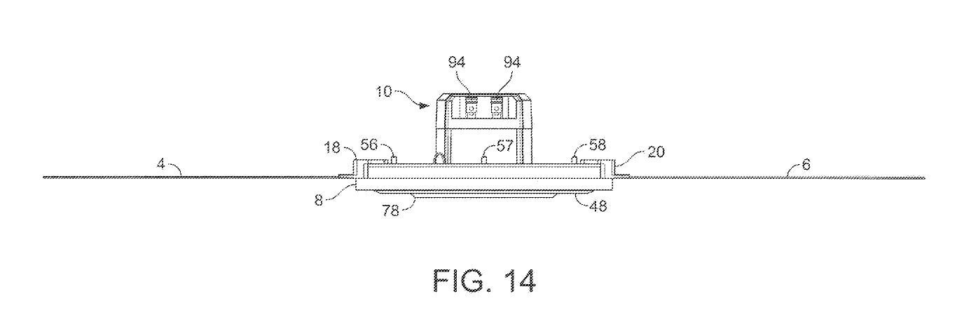

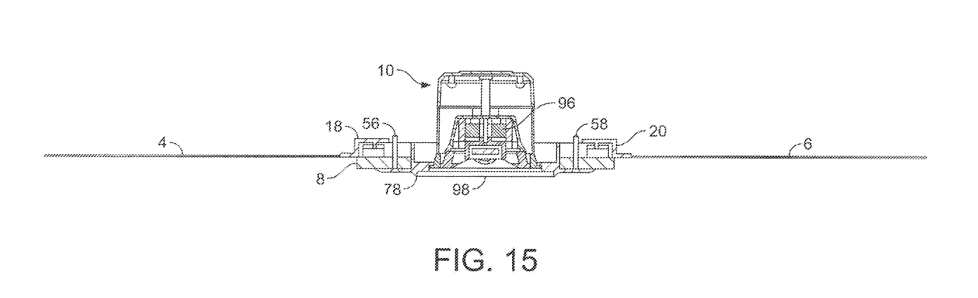

With reference to FIGS. 10 and 11, the second part 2 also may be formed from a one piece moulding of ABS and includes an annular shoulder 60 which projects radially inwardly from the lower part of the boss 44. As can be seen from FIG. 10, strengthening ribs, such as the rib 62, which are equi-angularly arranged around the boss, extend radially from the boss to a cylindrical wall 64 which is formed integrally with the inner edge of the shoulder 60 and, as with the shoulder 60, is coaxial with the boss 44. Three equi-angularly arranged passages, two of which are shown at 66 and 68, extend axially from the reverse side of the shoulder 60 and are terminated at their lower end in screw holes 70-72 (FIG. 4).

The shoulder 60 acts as a seat for limiting the extent by which the loudspeaker 10 can be inserted into the bracket assembly, with the screw holes and associated passages (each of which has a respective screw threaded bushing) enabling the loudspeaker to be screwed into position in the bracket assembly.

An annular ledge 74 extends radially inwardly from the wall 64 at a position axially set back from the shoulder 60. The ledge defines a gap 76 that co-operates with a protuberance on the loudspeaker 10 to ensure that the loudspeaker and second part 2 are correctly angularly positioned relative to each other (with the screw holes 70-72 in alignment with corresponding holes in the loudspeaker 10) when the loudspeaker is inserted into the bracket assembly.

The second part is also provided with a lower ridge 78 which is annular, coaxial with the boss 44 and which functions as the mud bank/ring of the bracket assembly. The second part 2 is supplied with a plaster shield 80 that is temporarily held in position by protuberances on the shield 80, such as the protuberances, which extend into the screw holes 50-53. A finger hole 84 is provided in the centre of the shield 80 to facilitate removal of the shield once the ceiling has been plastered.

The loudspeaker 10 has a cylindrical body from which a pair of radial protuberances 86 extend axially from one side of a lower flange 88 provided with screw holes 90-92 by which the loudspeaker 10 can be screwed onto the second part 2 of the assembly by screws extending through those holes and into the corresponding screw holes/passages in the shoulder 60. The loudspeaker includes terminals 94 for connecting the wires to a voice coil 96 which is, in turn, coupled to a diaphragm 98. The voice coil 96 and diaphragm 98 form part of a driver for the loudspeaker, which is a base or mid-range unit. The components of the loudspeaker (other than the protuberances 86) are conventional, and will not therefore be described in detail. The protuberances 86 are used to achieve angular alignment of the loudspeaker relative to the lower part, so that the screw holes on the loudspeaker align with the corresponding holes in the shoulder 60 when the loudspeaker is inserted into the lower part 2, since this can only happen if the protuberances 86 are aligned with, and therefore pass into, the gap 76.

One way of installing the bracket assembly and loudspeaker will now be described.

Firstly, the preconstruction bracket 1 is installed into a ceiling void, using a standard preconstruction method by which the bracket is mounted between the ceiling joists using the mesh wings 6 and 8. Once fixed into the correct position, prewiring for the speaker occurs, where the wires are temporarily tied to the preconstruction D-ring 40 of the bracket 1.

The plasterboard panel 8 is then installed underneath the preconstruction bracket 1. The installer will then cut a standard 120 mm hole in the plasterboard panel 8 using a circular hole saw or ceiling saw. The inside diameter of the preconstruction bracket (i.e. of the wall 30) should then be able to sit flush with the hole, ready for the second part 2 to be installed. The necessary location of the hole to be cut can be determined by standard methods, for example measuring the distance of the centre of the preconstruction bracket from the edges of the ceiling.

Once the hole has been cut, the second part 2 is then inserted through the hole, with the boss 44 sliding into the aperture defined by the wall 30, and with the plaster shield 80 in place on the second part. As described above, the protuberance 42 and slot 46 co-operate so that the boss 44 can only be inserted when in one angular position relative to the preconstruction bracket 1. Once the flange 48 of the second part is sat flat against the panel 8, it is in the correct orientation and the screw holes in the flange 48 will be aligned with the screw holes in the preconstruction bracket 1. The screws (for example the screws 56-58) can then be fixed straight through the plaster board panel 8 into the preconstruction bracket 1 creating a clamping action. This allows the second part 2 to be fixed to any ceiling thickness while locating the protuberance 42 of the preconstruction bracket 1 in the slot 46. The passages 36-39 allow the screws to go all the way through from one side to the other. If 30 mm screws are used, the assembly has the ability to fix through ⅜″, ½″ and ⅝″ thick plaster board using the same clamping mechanism.

To create a desirable “flush” finish mesh tape can be added to the edges of the flange 48 and up to two layers of compound and plaster smoothed up to the edge of the aperture which is blocked by the shield 80, i.e. up to the ridge 78, and slightly over the ridge onto the shield 80. Once dry, this is then sanded down to reveal the edges of the plaster shield 80, and the ceiling is then painted. After completion of the ceiling, the plaster shield 80 can be removed. The speaker wires are then untied from the D-ring 40 and connected to the speaker terminals 94. The speaker can then be placed within the aperture defined by the bracket assembly.

As explained above, the speaker 10 can only be located in the bracket assembly in one angular position, in view of the effect of the protuberances 86 and gap 76. If orientated correctly, the flange 88 of the speaker will lie flat against the shoulder 60 which therefore acts as a stop that limits the extent to which the loudspeaker can be inserted.

The correct angular location of the speaker relative to the bracket assembly ensures that the screw holes in the speaker flange 88 line up with the corresponding holes in the shoulder 60 so that the speaker can then be screwed into position. The speaker grill 14 can then be installed.

The axial distance between the lower edge of the ridge 78 and the shoulder, and the thickness of the flange 88 of the speaker 10 are such that the grill will be substantially flush with the finished ceiling (regardless of the thickness of the plaster board 8).

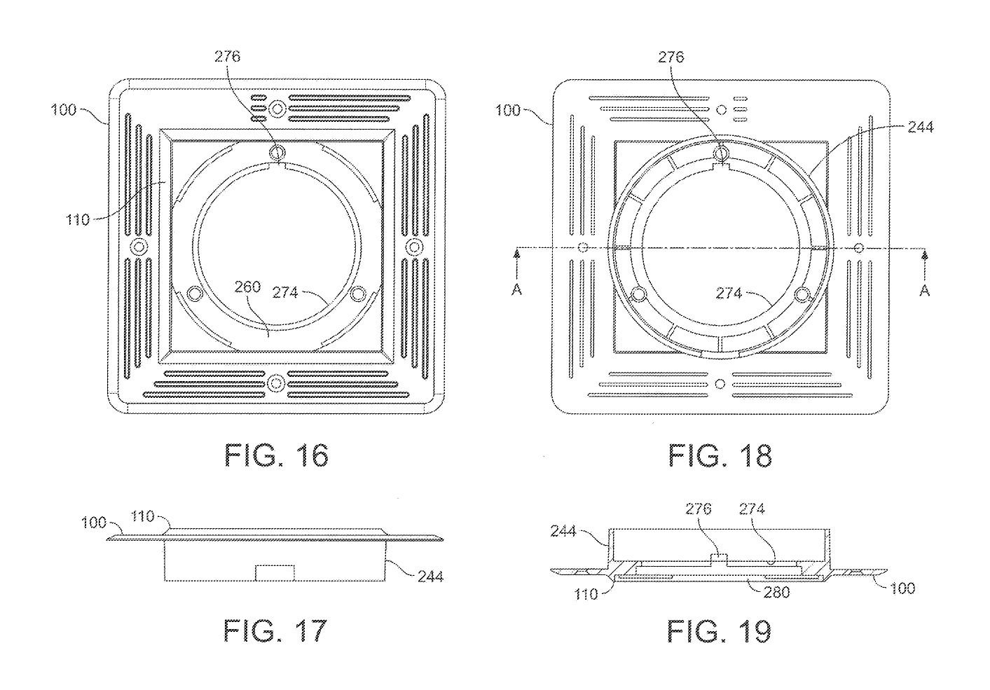

FIGS. 16-19 show a version of the second part of the bracket assembly which differs only from the first described version (i.e. the part 2) by virtue of having a square flange 100 and square ridge 110 instead of the annular flange 48 and annular ridge 78. All other components of the second part shown in FIGS. 16-19 are the same as the corresponding parts of the second part 2 and are developed by the same reference numbers, raised by 200. The arrangement shown in FIGS. 16-19 can therefore be fitted onto the same type of preconstruction bracket as the preconstruction bracket 1, and allow a loudspeaker with a square grill to be installed.

1. A bracket for use in mounting a loudspeaker in a wall or a ceiling, the bracket comprising a ridge for defining at least part of a perimeter of an aperture in the finished wall or ceiling; an abutment for limiting a distance by which the loudspeaker can be inserted into the aperture in a wall panel or a ceiling panel; and a retainer for cooperating with one or more fasteners to retain the loudspeaker in position with respect to the bracket.

2. The bracket according to claim 1, in which the bracket also includes an attachment structure, by which the bracket can be directly attached to the wall panel or the ceiling panel.

3. The bracket according to claim 1, in which the ridge is continuous so as to enclose the aperture.

4. The bracket according to claim 3, in which the ridge is annular or polygonal.

5. The bracket according to claim 1, in which the abutment comprises a radial shoulder.

6. The bracket according to claim 5, in which the radial shoulder is annular.

7. The bracket according to claim 1, in which the bracket comprises a bracket assembly having a first part for attachment to a structural support behind the wall or above the ceiling, and a second, separate part having said ridge and said abutment, the second part being attachable both to the first part and the wall panel or the ceiling panel.

8. The bracket according to claim 7, in which the second part of the bracket assembly includes a protuberance for insertion through the aperture in the wall or the ceiling panel, the first part having receiving structure for receiving the protuberance to provide location of the two parts relative to each other at any of a range of possible axial positions.

9. The bracket according to claim 8, in which the protuberance comprises a boss.

10. The bracket according to claim 9, in which the boss comprises a cylindrical wall.

11. The bracket according to claim 10, in which the abutment projects radially inwardly from the boss.

12. The bracket according to claim 9, in which the receiving structure comprises an aperture or a passage in the first part into which the boss is a sliding fit.

13. The bracket according to claim 12, in which the receiving structure, in use, locates the boss at a position coaxial with the aperture or the passage in the first part.

14. The bracket according to claim 7, in which the first part and the second part are configured to be fastened together by fasteners, extending through the wall panel or the ceiling panel, which are thereby clamped between the first part and the second part of the bracket assembly.

15. The bracket according to claim 14, in which the first part has passages or through holes for enabling fastening screws, having been inserted through the second part, to pass through or into the first part by a variable distance to enable panels of a range of possible thicknesses to be clamped between the first part and the second part of the bracket assembly.

16. The bracket according to claim 15, in which the second part includes a flange that surrounds the ridge and sits, in use, against an opposite side of the wall or the ceiling panel from the first part of the bracket assembly, the flange including holes or passages for said screws, for fastening the first part and the second part together.

17. The bracket according to claim 16, in which the first part and the second part of the bracket assembly include angular location structure for ensuring that the second part is inserted into the first part with the screw holes or the passages of the second part aligned with the screw passages or the through holes in the first part.

18. The bracket according to claim 17, in which the angular location structure comprises a protuberance on one of the first part or the second part that cooperates with a female receptor on the other of the first or the second part, to allow insertion of the second part only when in a predetermined angular position relative to the first part.

19. The bracket according to claim 16, in which the second part includes further screw holes via which the loudspeaker can be attached to the bracket by screws, the second part also having loudspeaker angular location structure for ensuring angular alignment between the loudspeaker and the bracket assembly.

20. The bracket according to claim 19, in which the loudspeaker angular location structure comprises a radial ledge having a gap or break for accommodating a complimentary protuberance on the loudspeaker.

21. The bracket according to claim 1, in combination with the loudspeaker.
